(19) United States
(12) Patent Application Publication
(10) Pub. No.: US 2009/0237628 A1
(43) Pub. Date: Sep. 24, 2009

(54) OPTICAL REFLECTION DEVICE AND IMAGE PROJECTOR INCLUDNG THE SAME

(76) Inventors: Shigeo Furukawa, Osaka (JP); Jirou Terada, Osaka (JP); Shinsuke Nakazono, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/404,518

(22) Filed: Mar. 16, 2009

(30) Foreign Application Priority Data
Mar. 18, 2008 (JP) 2008-069029

(51) Int. Cl. G03B 21/28; G02B 26/08

(52) U.S. Cl. 353/98; 359/223.1

(57) ABSTRACT

An optical reflection device includes a mirror adapted to reflect light thereon, a first meander vibration beam supporting the mirror rotatably about the first rotation axis, a movable frame connected to the first meander vibration beam, a second meander vibration beam supporting the movable frame rotatably about a second rotation axis, and a supporter connected to the second meander vibration beam. The first meander vibration beam meanderingly extends along a first rotation axis, and has a first end and a second end opposite to the first end. The movable frame is connected to the second end of the first meander vibration beam. The second meander vibration beam extends meanderingly along the second rotation axis perpendicular to the first rotation axis, and has a third end and a fourth end opposite to the third end. The supporter is connected to the fourth end of the second meander vibration beam. The mirror is coupled to the movable frame only via the first meander vibration beam. This optical reflection device has a large angle by which the mirror rotates about the first rotation axis.

### FIELD OF THE INVENTION

The present invention relates to an optical reflection device and an image projector including the device.

### BACKGROUND OF THE INVENTION

FIG. 16 is a perspective view of conventional optical reflection device 501. Optical reflection device 501 includes mirror 201, two first meander vibration beams 202 joined to respective ones of both ends of mirror 201, movable frame 203 joined to first meander vibration beams 202, second meander vibration beams 204 joined to respective ones of both ends of movable frame 203, and supporter 205 supporting second meander vibration beam 204. Movable frame 203 encloses first meander vibration beam 202 and mirror 201. First meander vibration beams 202 swing about rotation axis 206. Second meander vibration beams 204 swing about rotation axis 207. Rotation axes 206 and 207 are perpendicular to each other.

First meander vibration beams 202 extend meanderingly along rotation axis 206, and cause mirror 201 to rotate about rotation axis 206. Second meander vibration beams 204 extend meanderingly along rotation axis 207, and cause mirror 201 to rotate about rotation axis 207.

Mirror 201 is supported at both ends thereof with first meander vibration beams 202 and has a both-end-supported structure. Movable frame 203 having the both-end-supported structure is supported at both ends thereof with second meander vibration beams 204.

In optical reflection device 501, swinging vibration beams 202 and 204 swing to cause mirror 201 rotates about rotation axes 206 and 207. Light enters onto mirror 201 which rotates, and is reflected on mirror 201, thereby moving and scanning a screen along an X-axis and a Y-axis so as to project an image, such as characters, on the screen. That is, when mirror 201 rotates about rotation axis 206, the reflected light moves and scans along the X-axis on the screen. When mirror 201 rotates about rotation axis 207, the reflected light moves and scans along the Y-axis on the screen.

In order to project the image on the screen, the reflected light generally scans along the X-axis plural times while scanning along the Y-axis once. That is, the scanning frequency along the X-axis is higher than that along the Y-axis.

In order to make the scanning frequency along the X-axis higher than that along the Y-axis, the meander length of first meander vibration beam 202 is determined to be adequately shorter than that of second meander vibration beam 204. However, a smaller meander length of first meander vibration beam 202 decreases the angle by which mirror 201 rotates about rotation axis 206, and decreases the scanning length along the X-axis.

In order to project a precise image having a high resolution, the ratio of the vibration frequency of first meander vibration beam 202 to that of second meander vibration beam 204 is required to be large. In order to increase this ratio, second meander vibration beam 204 is required to be long, accordingly increasing the size of optical reflection device 501.

### SUMMARY OF THE INVENTION

An optical reflection device includes a mirror adapted to reflect light thereon, a first meander vibration beam supporting the mirror rotatably about the first rotation axis, a movable frame connected to the first meander vibration beam, a second meander vibration beam supporting the movable frame rotatably about a second rotation axis, and a supporter connected to the second meander vibration beam. The first meander vibration beam meanderingly extends along a first rotation axis, and has a first end and a second end opposite to the first end. The movable frame is connected to the second end of the first meander vibration beam. The second meander vibration beam extends meanderingly along the second rotation axis perpendicular to the first rotation axis, and has a third end and a fourth end opposite to the third end. The supporter is connected to the fourth end of the second meander vibration beam. The mirror is coupled to the movable frame only via the first meander vibration beam.

This optical reflection device has a feature, a large angle by which the mirror rotates about the first rotation axis.

### BRIEF DESCRIPTION OF DRAWINGS

FIG. 1A is a top view of an optical reflection device according to Exemplary Embodiment 1 of the present invention.

FIG. 1B is an enlarged top view of the optical reflection device according to Embodiment 1.

FIG. 2 is a sectional view of the optical reflection device according to Embodiment 1.

FIG. 3 is a schematic diagram of an image projector according to Embodiment 1.

FIG. 4 is a top view of an optical reflection device according to Exemplary Embodiment 2 of the invention.

FIG. 5 is a top view of a mirror of the optical reflection device according to Embodiment 2.

FIGS. 6A to 6E are sectional views of mirrors of the optical reflection device according to Embodiment 1.

FIG. 7A shows evaluation results of the optical reflection device according to Embodiment 2.

FIG. 7B is a top view of the mirror of the optical reflection device according to Embodiment 2.

FIG. 8 is a top view of an optical reflection device according to Exemplary Embodiment 3 of the invention.

FIG. 9A is a sectional view of the optical reflection device according to Embodiment 3.

FIG. 9B is a sectional view of the optical reflection device according to Embodiment 3.

FIG. 10 is a schematic diagram of an image projector according to Embodiment 3.

FIG. 11 is a top view of another optical reflection device according to Embodiment 3.

FIG. 12 shows evaluation results of the optical reflection device according to Embodiment 3.

FIG. 13 is a schematic diagram of a movable frame of the optical reflection device according to Embodiment 3.

FIG. 14 is a top view of a comparative example of an optical reflection device.

FIG. 15 is a top view of an optical reflection device according to Exemplary Embodiment 4 of the invention.

FIG. 16 is a perspective view of a conventional optical reflection device.

### DETAILED DESCRIPTION OF PREFERRED EMBODIMENTS

### Exemplary Embodiment 1

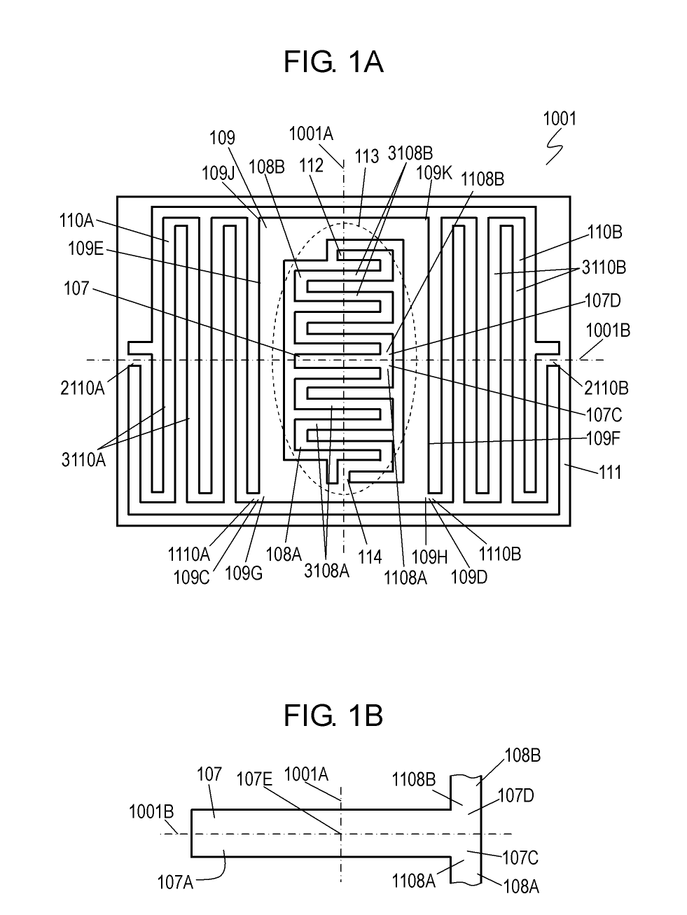

FIG. 1A is a top view of optical reflection device 1001 according to Exemplary Embodiment 1 of the present invention. Optical reflection device 1001 includes mirror 107 adapted to reflect light thereon, single first meander vibration beam 108A connected to mirror 107, movable frame 109 connected to first meander vibration beam 108A, second meander vibration beam 110A connected to movable frame 109, third meander vibration beam 110B connected to movable frame 109, supporter 111 connected to second meander vibration beam 110A and third meander vibration beam 110B, and further meander vibration beam 108B connected to mirror 107. Movable frame 109 surrounds meander vibration beams 108A and 108B and mirror 107. Supporter 111 has a frame shape surrounding meander vibration beams 110A and 110B and movable frame 109. Mirror 107 is arranged substantially at the center of movable frame 109. First meander vibration beam 108A has end 1108A connected to end 107C of mirror 107, and causes mirror 107 to rotate about first rotation axis 1001A. Meander vibration beam 108B has end 1108B connected to end 107D of mirror 107 opposite to end 107C in a direction along first rotation axis 1001A. Meander vibration beams 108A and 108B extend meanderingly along first rotation axis 1001A. Second meander vibration beam 110A has end 1110A connected to end 109C of movable frame 109, and causes movable frame 109 to rotate about second rotation axis 1001B. Third meander vibration beam 110B has end 1110B connected to end 109D of movable frame 109 opposite to end 109C in a direction along second rotation axis 1001B, and causes movable frame 109 to rotate about second rotation axis 1001B. Meander vibration beams 110A and 110B extend meanderingly along second rotation axis 1001B. The periphery of mirror 107 except end 107C is not connected to movable frame 109.

FIG. 1B is an enlarged top view of optical reflection device 1001 for showing details of mirror 107. Rotation axes 1001A and 1001B are substantially perpendicular to each other. Rotation axes 1001A and 1001B cross each other preferably at center 107E of mirror 107.

End 114 of first meander vibration beam 108A opposite to end 1108A is connected to movable frame 109, thus being a fixed end. End 112 of meander vibration beam 108B opposite to end 1108B is not connected to movable frame 109, thus being an open end. Meander vibration beams 108A and 108B and mirror 107 provides combination structure 113, and has a cantilever structure in which end 114 of first meander vibration beam 108A is the fixed end.

First meander vibration beam 108A faces meander vibration beam 108B across mirror 107 along first rotation axis 1001A.

End 2110A of second meander vibration beam 110A opposite to end 1110A is connected to supporter 111. End 2110B of third meander vibration beam 110B opposite to end 1110B is connected to supporter 111. Second meander vibration beam 110A faces third meander vibration beam 110B across movable frame 109 along second rotation axis 1001B.

In optical reflection device 1001 according to Embodiment 1, ends 1110A and 1110B of meander vibration beams 110A and 110B are positioned at ends 109G and 109H of sides 109E and 109F of movable frame 109 opposite to each other, respectively, however, may be positioned at ends 109J and 109K of sides 109E and 109F opposite to ends 109G and 109H, respectively.

First meander vibration beam 108A extending meanderingly along first rotation axis 1001A has plural portions 3108A extending in a direction of second rotation axis 1001B perpendicular to first rotation axis 1001A. Meander vibration beam 108B extending meanderingly along second rotation axis 1001B has plural portions 3108B extending in a direction of second rotation axis 1001B perpendicular to first rotation axis 1001A. Second meander vibration beam 110A extending meanderingly along second rotation axis 1001B has plural portions 3110A extending in the direction of first rotation axis 1001A. Third meander vibration beam 110B extending meanderingly along second rotation axis 1001B has plural portions 3110B extending in the direction of first rotation axis 1001A.

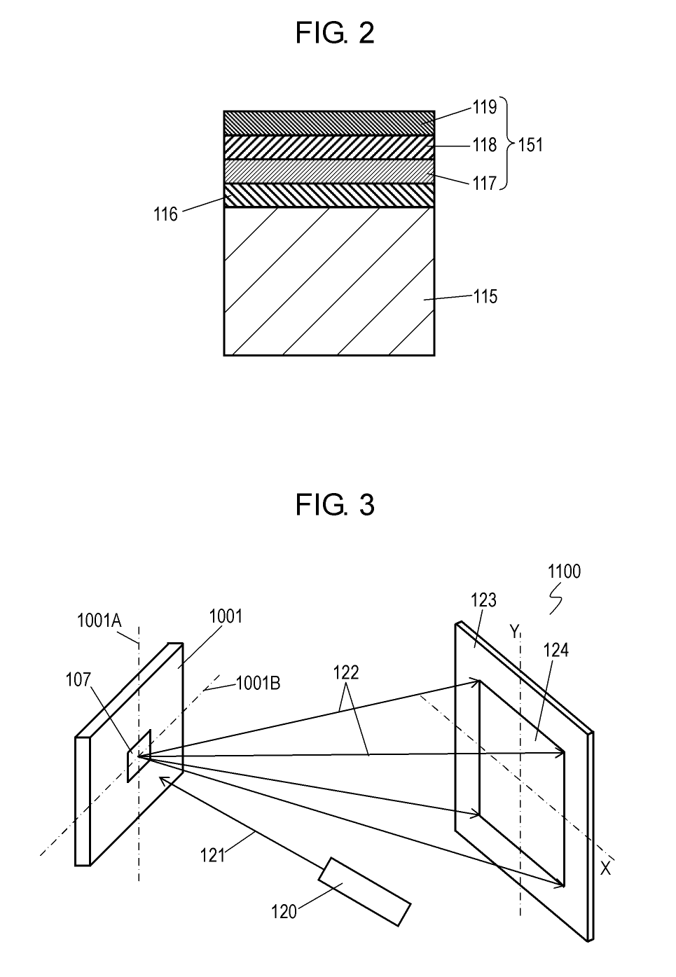

FIG. 2 is a sectional view of portions 3108A, 3108B, 3110A, and 3110B of meander vibration beams 108A, 108B, 110A, and 110B. Each of meander vibration beams 108A, 108B, 110A, and 110B includes silicon substrate 115, silicon oxide film 116 provided on silicon substrate 115, and piezoelectric actuator 151 provided on silicon oxide film 116. Piezoelectric actuator 151 includes lower electrode layer 117 provided on silicon oxide film 116, piezoelectric layer 118 provided on lower electrode layer 117, and upper electrode layer 119 provided on piezoelectric layer 118. Lower electrode layer 117 may be grounded. Piezoelectric layer 118 is made of piezoelectric material.

Optical reflection device 1001 is formed by etching silicon substrate 115. Particularly, portions of silicon substrate 115 constituting meander vibration beams 108A, 108B, 110A, and 110B and mirror 107 are etched and are thinner than the other portions of silicon substrate 115. The thickness of meander vibration beams 108A, 108B, 110A, and 110B and mirror 107 is 120 μm. The thickness of movable frame 109 and supporter 111 is 525 μm. Meander vibration beams 108A, 108B, 110A, and 110B and mirror 107 are thus thinner than movable frame 109 and supporter 111.

Meander vibration beams 108A, 108B, 110A, and 110B are thinner than movable frame 109 and supporter 111, and elastically deform more easily than movable frame 109 and supporter 111, thereby vibrating at a large amplitude. Movable frame 109 is thicker than meander vibration beams 108A, 108B, 110A, and 110B and functions as a weight for meander vibration beams 110A and 110B, which increases the amplitude of the vibration of meander vibration beams 110A and 110B about second rotation axis 1001B. Supporter 111 is thick and allows optical reflection device 1001 to be easily handled, thus increasing the mechanical strength of optical reflection device 1001.

Lower electrode layer 117 may be made of platinum. Upper electrode layer 119 may be made of gold. Piezoelectric layer 118 may be made of lead zirconate titanate, Pb(Zrₓ,Ti₁₋ₓ)O₃(x=0.525). These layers may be formed by a film-forming method, such as deposition, sol-gel method, chemical vapor deposition (CVD), or sputtering.

An operation of optical reflection device 1001 will be described below.

Alternating-current (AC) voltages having respective resonance frequency of first meander vibration beam 108A, second meander vibration beam 110A, third meander vibration beam 110B, and meander vibration beam 108 are applied to upper electrode layer 119 of first meander vibration beam 108A, second meander vibration beam 110A, third meander vibration beam 110B, and meander vibration beam 108 so as to drive piezoelectric actuator 151 of each of first meander vibration beam 108A, second meander vibration beam 110A, third meander vibration beam 110B, and meander vibration beam 108B. First meander vibration beam 108A, second meander vibration beam 110A, third meander vibration beam 110B, and meander vibration beam 108B vibrate at large amplitude due to resonance, thereby rotating and swinging mirror 107 by a large angle about rotation axes 1001A and 1001B.

The polarity of the AC voltage applied to upper electrode layer 119 changes, and causes meander vibration beams 110A and 110B to vibrate so that the warping directions of portions 3110A and 3110B of meander vibration beams 110A and 110B parallel to first rotation axis 1001A change. This vibration causes movable frame 109 to vibrate so that ends 109G and 109H of movable frame 109 are displaced in a direction opposite to a direction in which ends 109J and 109K are displaced, thereby rotating and swinging mirror 107 about second rotation axis 1001B while center 107E of mirror 107 is not displaced.

The polarity of the AC voltage supplied to upper electrode layer 119 changes, and causes meander vibration beams 108A and 108B to vibrate so that the warping direction of portions 3108A and 3108B of meander vibration beams 108A and 108B parallel to second rotation axis 1001B change. This vibration causes movable frame 109 to vibrate so that ends 109G and 109J of movable frame 109 are displaced in a direction opposite to a direction in which ends 109H and 109K are displaced, thereby rotating and swinging mirror 107 about first rotation axis 1001A while center 107E of mirror 107 is not displaced.

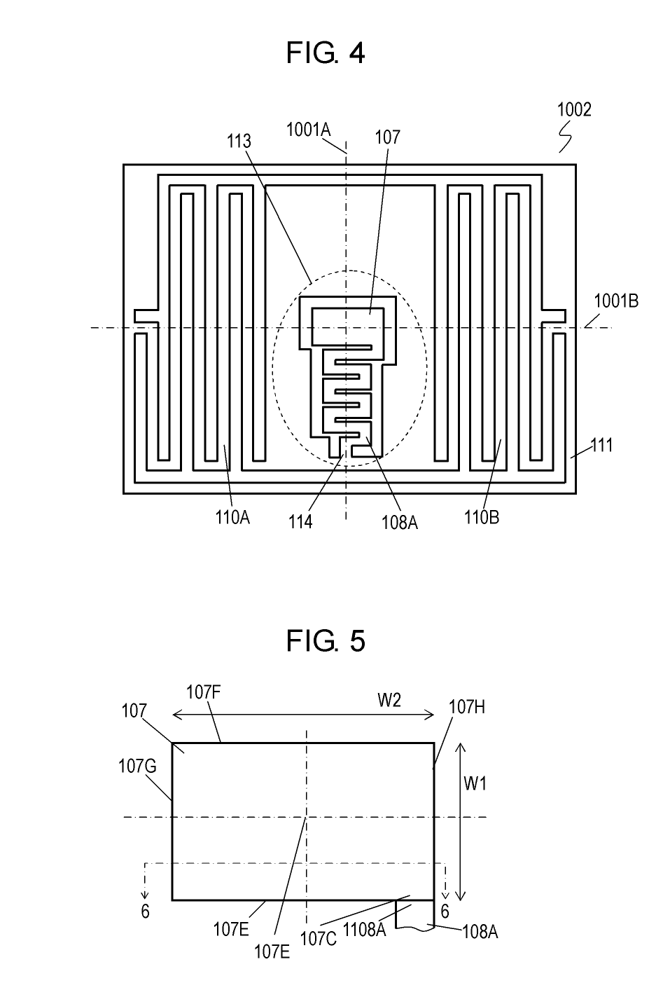

FIG. 3 is a schematic diagram of image projector 1100 including optical reflection device 1001. Light 121 is emitted onto mirror 107 from light source 122, such as a laser light source. Mirror 107 reflects light 121 so that reflected light 122 reaches screen 123 while rotating and swinging about rotation axes 1001A and 1001B. While mirror 107 rotates about first rotation axis 1001A, reflected light 122 scans screen 123 in a direction of an X-axis perpendicular to first rotation axis 1001A. Similarly, while mirror 107 rotates about second rotation axis 1001B, reflected light 122 scans screen 123 in a direction of a Y-axis perpendicular to second rotation axis 1001B. Thus, mirror 107 of optical reflection device 1001 allows reflected light 122 to scan screen 123 in the directions of the X-axis and Y-axis, thereby projecting image 124 on screen 123. Rotation axis 1001A is perpendicular to rotation axis 1001B, however may not be exactly perpendicular to rotation axis 1001B by about 1 degree due to manufacturing error or measuring error. Thus, rotation axis 1001A substantially perpendicular to rotation axis 1001B provides the same effects.

In optical reflection device 1001 according to Embodiment 1, combination structure 113 including mirror 107 and meander vibration beams 108A and 108B has a cantilever structure. End 112 of meander vibration beam 108B is a free end which opens, and is connected to nothing, mirror 107 vibrates and rotates by a large angle about first rotation axis 1001A, thereby allowing reflected light 122 to scan widely in the direction of the Y-axis.

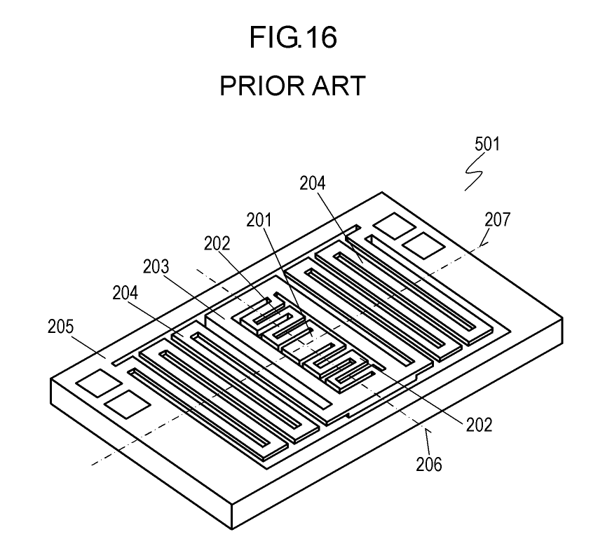

In conventional optical reflection device 501 shown in FIG. 16, both ends of mirror 201 are fixed to movable frame 203 via meander vibration beams 202. The fixed ends of meander vibration beams 202 restrain the rotation of mirror 201 about rotation axis 206, thereby preventing mirror 208 from rotating by a large angle.

In image projector 1100 shown in FIG. 3, reflected light 122 scans in the direction of the X-axis at a higher frequency than in the direction of the Y-axis. In other words, mirrors 107 and 201 vibrate and rotate about rotation axes 206 and 1001A at a higher frequency than about rotation axes 207 and 1001B. Hence, conventional optical reflection device 501 rotates about rotation axis 206 by a further small angle.

In optical reflection device 1001 according to Embodiment 1, mirror 107 has the free end, namely, end 112 of the meander vibration beam opens, and coupled to movable frame 109 only via single first meander vibration beam 108A, thus preventing meander vibration beam 108B from receiving a reactive force from movable frame 109. Consequently, mirror 107 and meander vibration beams 108A and 108B deform and are displaced more freely than mirror 201 and meander vibration beam 202 of conventional optical reflection device 501. Hence, mirror 107 rotates about first rotation axis 1001A by a large angle, thereby allowing reflected light 122 to scan widely in the direction of the X-axis direction. In optical reflection device 1001 according to Embodiment 1, mirror 107 rotates about first rotation axis 1001A by an angle approximately 4.8 times that about rotation axis 206 in conventional optical reflection device 501 shown in FIG. 16.

In optical reflection device 1001 according to Embodiment 1, mirror 107 is located substantially at the center of movable frame 109. Center 107E of mirror 107 does not move while mirror 107 vibrates, thus reducing the variation at center 107E of mirror 107. This prevents image 124 projected by optical reflection device 1001 from distorting.

Although optical reflection device 1001 can have a small size, meander vibration beams 108A, 108B, 110A, and 110B extend meanderingly and can be long, thereby increasing the rotation angle of mirror 107.

### Exemplary Embodiment 2

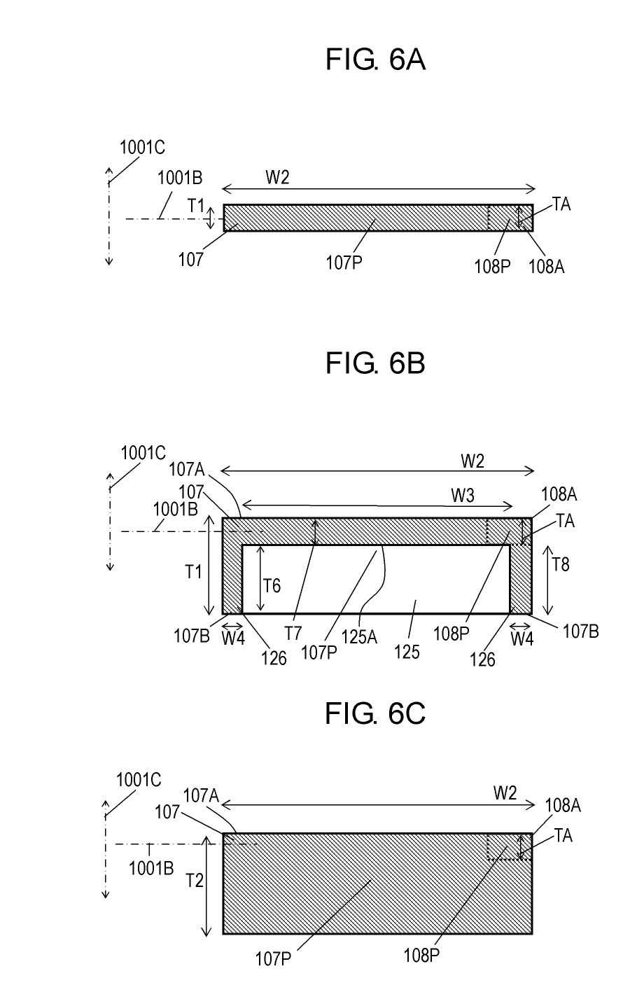

FIG. 4 is a top view of optical reflection device 1002 according to Exemplary Embodiment 2 of the present invention. In FIG. 4, components identical to those of optical reflection device 1001 according to Embodiment 1 shown in FIG. 1A are denoted by the same reference numerals, and their description will be omitted. Optical reflection device 1002 according to Embodiment 2 does not include meander vibration beam 108B of optical reflection device 1001 shown in FIG. 1A.

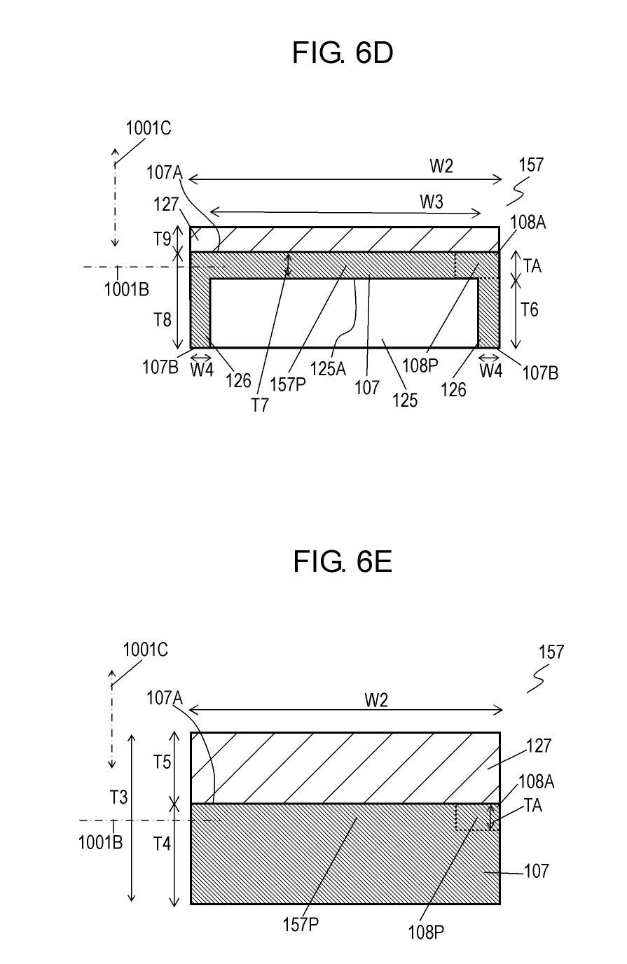

FIG. 5 is a top view of mirror 107. Mirror 107 located substantially at the center of movable frame 109 has a rectangular shape having sides 107G and 107H in the direction of first rotation axis 1001A and sides 107E and 107F in the direction of second rotation axis 1001B perpendicular to first rotation axis 1001A. According to Embodiment 2, width W1 of sides 107G and 107H is 1100 μm, and width W2 of sides 107E and 107F is 1800 μm.

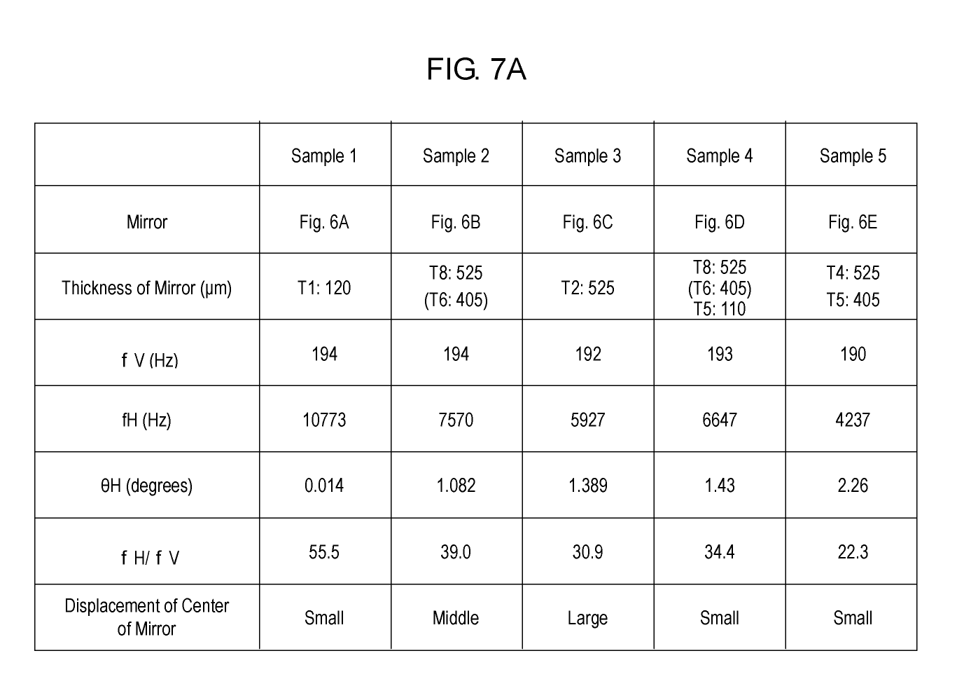

FIGS. 6A to 6E are sectional views of mirror 107 at line 66 shown in FIG. 5. Mirror 107 shown in FIGS. 6A to 6E has a thickness in direction 1001C perpendicular to rotation axes 1001A and 1001B. First meander vibration beam 108A has thickness TA. Thickness TA of first meander vibration beam 108A is 120 μm.

Thickness T1 of mirror 107 shown in FIG. 6A in direction 1001C is 120 μm, which is the same as thickness TA of first meander vibration beam 108A. Thickness T2 of mirror 107 shown in FIG. 6C in direction 1001C is 525 μm, and is larger than thickness TA of first meander vibration beam 108A. Thickness T3 of mirror 107 in direction 1001C shown in FIG. 6E is 930 μm, which is larger than thickness TA of first meander vibration beam 108A.

Mirror 107 shown in FIGS. 6B and 6D has recess 125 formed in lower surface 107B of mirror 107. Recess 125 is surrounded by projection 126 projecting from an outer edge of mirror 107. Projection 126 has a frame shape. Height T6 of projection 126 in direction 1001C from bottom 125A of recess 125 is 405 μm. Thickness T7 of mirror 107 from bottom 125A of recess 125 to upper surface 107A of mirror 107 is 120 μm, which is substantially identical to thickness TA of first meander vibration beam 108A. The sum of height T6 of projection 126 and thickness T7 of mirror 107 is larger than thickness TA of first meander vibration beam 108A.

In the fabricating of optical reflection device 1002, meander vibration beams 108A, 110A, and 110B are thinned by etching as well as the fabricating of optical reflection device 1001 shown in FIG. 1A. Mirror 107 shown in FIG. 6A is formed in the same etching process in which meander vibration beams 108A, 110A, and 110B are formed. Recess 125 shown in FIGS. 6B and 6D is formed in the same etching process in which meander vibration beams 108A, 110A, and 110B are formed. Hence, thickness TA of meander vibration beams 108A, 110A, and 110B is identical to thickness T1 of mirror 107 shown in FIG. 6A and to thickness T7 of mirror 107 at recess 125, that is, between bottom upper surface 107A of mirror 107 and bottom 125A of recess 125, shown in FIGS. 6B and 6D.

Weight layer 127 is provided on upper surface 107A of mirror 107 shown in FIGS. 6D and 6E. Weight layer 127 can be formed by, e.g. depositing silicon identical to the material of silicon substrate 115, or can be formed by depositing other material having a high density and can be strongly bonded with silicon substrate 115.

In optical reflection device 1002, mirror 107 is coupled to movable frame 109 only via single first meander vibration beam 108A, and optical reflection device 1002 does not include meander vibration beam 108B shown in FIG. 1A. This structure allows first meander vibration beam 108A to have a small length in the direction of first rotation axis 1001A, and the small length of first meander vibration beam 108A realizes high frequency fH of mirror 107 about first rotation axis 1001A to allow reflected light 122 to scan at high speed in the direction of the X-axis direction shown in FIG. 3. Higher frequency fH generally results in smaller rotation angle θH by which mirror 107 rotates about first rotation axis 1001A. In optical reflection device 1002, mirror 107 has a cantilever structure coupled to movable frame 109 only via first meander vibration beam 108A, allowing mirror 107 and first meander vibration beam 108A to be displaced and deform flexibly, thereby providing relatively large rotation angle θH of mirror 107.

Optical reflection device 1002 shown in FIG. 4 does not include meander vibration beam 108B of optical reflection device 1001 shown in FIG. 1A. Hence, the area in which meander vibration beam 108B is located in device 1001 shown in FIG. 1A is a portion of movable frame 109 in device 1002 in FIG. 4. This structure increases frequency fV at which mirror 107 vibrates and rotation angle θV by which mirror 107 rotates about second rotation axis 1001B, caused by the larger mass of movable frame 109 in device 1002 in FIG. 4 than in device 1001 in FIG. 1.

Thus, frequency fV at which mirror 107 vibrates and rotates about second rotation axis 1001B is decreased to increase ratio fH/fV. This increases scanning lines of image 124 parallel to the X-axis, allowing optical reflection device 1002 to project image 124 at a high resolution on screen 123.

Larger rotation angles θH and θV provide larger image 124.

As shown in FIGS. 6B to 6E, the thickness of at least a portion of mirror 107 in direction 1001C is larger than thickness TA of first meander vibration beam 108A so as to increase the mass of mirror 107, thereby increasing rotation angle θH about first rotation axis 1001A.

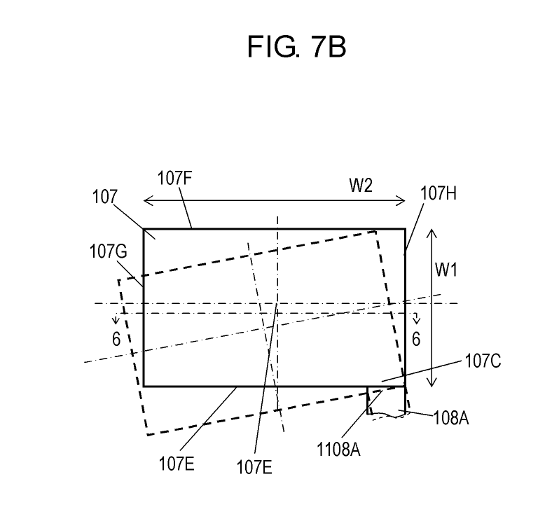

FIG. 7A shows evaluation results of samples 1 to 5 of optical reflection device 1002 including mirrors 107 shown in FIGS. 6A to 6E, respectively. In samples 2 and 4 for optical reflection device 1002 including mirrors 107 shown in FIGS. 6B and 6D, respectively, the mass of mirror 107 is adjusted by adjusting width W4 of projection 126 on lower surface 107B of mirror 107 in the direction of second rotation axis 1001B. Hence, the mass of mirror 107 is adjusted to a predetermined mass to increase rotation angle θH.

The depth of recess 125 of mirror 107, i.e., height T6 of the projection, is identical to a depth by which silicon substrate 115 is etched to form meander vibration beams 108A, 110A, and 110B. This structure allows recess 125 to be formed simultaneously to meander vibration beam 108A, 110A, and 110B, thereby allowing optical reflection devices 1002 to be manufactured at high productivity.

In samples 4 and 5 of optical reflection device 1002 including mirrors 107 shown in FIGS. 6D and 6E, respectively, weight layer 127 is provided entirely on upper surface 7A of mirror 107. Mirror 107 is joined to weight layer 127 on upper surface 107A of mirror 107 to provide mirror body 157. Center 157P of mirror body 157 is positioned at a position roughly the same as center 108P of first meander vibration beam 108A. In sample 1 including mirror 107 shown in FIG. 6A, center 107P of mirror 107 is placed at a position roughly the same as center 108P of first meander vibration beam 108A in direction 1001C.

In samples 2 and 3 including mirrors 107 shown in FIGS. 6B and 6C, respectively, gravity center 107P of mirror 107 deviates from gravity center 108P of first meander vibration beam 108A in direction 1001C. Therefore, as shown in FIG. 7A, in samples 2 and 3, the position of center 107E of mirror 107 deviates in the direction of first rotation axis 1001A while first meander vibration beam 108A vibrates. FIG. 7B is a top view of mirror 107 having gravity center 109P deviate. As shown in FIG. 7B, the deviation of gravity center 107P of mirror 107 in the direction 1001C adds unnecessary swing vibration mode to mirror 107A in the plane including rotation axes 1001A and 1001B shown in FIG. 4 while mirror 107 swings about rotation axis 1001A. The addition of the swing vibration mode to mirror 107 causes the deviation of mirror center 107E in the direction of rotation axis 1001A as shown in FIG. 7B. Therefore, as shown in FIG. 7A, in samples 2 and 3, the position of center 107E deviates in the direction of rotation axis 1001A while first meander vibration beam 108A vibrates.

In samples 4 and 5 including mirrors 107 shown in FIGS. 6D and 6E, respectively, gravity center 157P of mirror body 157 is located at a position substantially identical to gravity center 108P of first meander vibration beam 108A in direction 1001C. This arrangement prevents the position of gravity center 107E of mirror 107 from deviating in the direction of first rotation axis 1001A while first meander vibration beam 108A vibrates, thereby projecting image 124 with small distortion. In mirror 107 according to Embodiment 2 shown in FIG. 6D, height T6 is 405 μm, thickness T7 is 120 μm, which is identical to thickness TA, thickness T8 is 585 μm, and thickness T9 is 110 μm. Width W3 is 1600 μm, and width W4 is 100 μm. In the case that mirror 107 is made of the same material, i.e., material having the same density, as material of weight layer 127, the above dimensions locate gravity center 157P of mirror body 157 at a position substantially identical to gravity center 108P of first meander vibration beam 108A in direction 1001C. In mirror 107 according to Embodiment 2 shown in FIG. 6E, thickness T4 of mirror 107 in direction 100C is 525 μm, and thickness T5 of weight layer 127 is 405 μm. In the case that mirror 107 is made of the same material, i.e., material having the same density, as material of weight layer 127, the above dimension locate the meander vibration beam 108A at the center of mirror body 127 in direction 1001C, and locate gravity center 157P of mirror body 157 substantially at gravity center 108P of first meander vibration beam 108A.

In sample 5 including mirror 107 shown in FIG. 6E, mirror 107 has an excessively large weight, accordingly lowering frequency fH while rotation angle θH is large, as shown in FIG. 7A. In sample 1 including mirror 107 shown in FIG. 6A, mirror 107 has a small weight, accordingly decreasing rotation angle θH, as shown in FIG. 7A

In sample 4 including mirror 107 shown in FIG. 6D, the volume of projection 126, namely, widths W3 and W4 and height T9 of weight layer 127 are effectively adjusted to adjust the weight of mirror body 157. Even if mirror body 157 vibrates, the position of center 107E of mirror 107 is prevented from deviation, and the weight of mirror body 157 is easily adjusted so that mirror body 157 of sample 4 vibrates at predetermined frequency fH by predetermined rotation θH.

In mirror 107 shown in FIG. 6D, projection 126 is provided along the outer periphery of lower surface 107B of mirror 107. Projection 126 may be provided at the center of lower surface 107B of mirror 107, or at both the outer periphery and the center. These structures allow the weight of mirror body 157 to be adjusted appropriately.

Projection 126 of mirror 107 functions as a weight provided on lower surface 107B of mirror 107. Projection 126 can be formed by etching lower surface 107B of mirror 107, and may be formed by stacking a weight layer having a film shape on lower surface 107B of mirror 107.

### Exemplary Embodiment 3

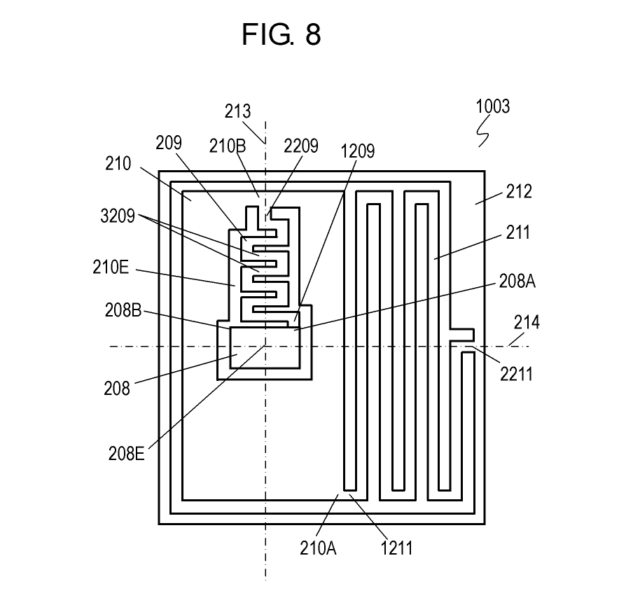

FIG. 8 is a top view of optical reflection device 1003 according to exemplary embodiment 3. Optical reflection device 1003 includes mirror 208 adapted to reflect light thereon, first meander vibration beam 209 connected to mirror 208, movable frame 210 connected to first meander vibration beam 209, second meander vibration beam 211 connected to movable frame 210, and supporter 212 connected to second meander vibration beam 211. Movable frame 210 has a frame shape surrounding first meander vibration beam 209 and mirror 208. Supporter 212 supports second meander vibration beam 211 and has a frame shape surrounding second meander vibration beam 211 and movable frame 210.

First meander vibration beam 209 extends meanderingly along first rotation axis 213, and has end 1209 and end 2209 opposite to end 1209. Meander vibration beam 209 includes plural portions 3209 extending in parallel with rotation axis 214 perpendicular to rotation axis 213. End 1209 of first meander vibration beam 209 is connected to mirror 208, and end 2209 is connected to movable frame 210. Mirror 208 has a cantilever structure coupled to movable frame 210 only via single first meander vibration beam 209. First rotation axis 213 is perpendicular to second rotation axis 214.

Second meander vibration beam 211 extends meanderingly along second rotation axis 214, and has end 1211 and end 2211 opposite to end 1211. End 1211 of second meander vibration beam 211 is connected to movable frame 210, and end 2211 is connected to supporter 212. Movable frame 210 has a cantilever structure coupled to supporter 212 only via single second meander vibration beam 211.

First meander vibration beam 209 rotates, for example, about first rotation axis 213 and swings mirror 208 at frequency fH while rotating mirror 208 by rotation angle θH about first rotation axis 213.

Second meander vibration beam 211 rotates, for example, about second rotation axis 214 and swings movable frame 210 at frequency fV while rotating movable frame 210 by rotation angle θV about second rotation axis 214. Second meander vibration beam 211 rotates movable frame 210 to swing mirror 208 at frequency fV while rotating movable frame 210 by rotation angle θV about second rotation axis 214.

Mirror 208 is arranged substantially at the center of the frame shape of movable frame 210. Rotation axes 213 and 214 cross each other at crossing point 208E preferably inside mirror 208. While mirror 208 rotates and swings about rotation axes 213 and 214, crossing point 208E does not move. Mirror 208 receives light at crossing point 208E to reflect the light and projects the light on the screen. The light enters to crossing point 208E and reflected by mirror 208 reaches the screen along a fixed optical path even while first meander vibration beam 209 and second meander vibration beam 211 vibrate, thereby projecting an image on the screen precisely. In optical reflection device 1003 according to Embodiment 3, crossing point 208E is positioned at the center of mirror 208. This arrangement positions crossing point 208E inside mirror 208 even if the positions of rotation axes 213 and 214 deviates due to a manufacturing error or other problems.

Movable frame 210 has ends 210A and 210B opposite to each other along first rotation axis 213. That is, ends 210A and 210B are positioned opposite to each other across second rotation axis 214 in between, and second rotation axis 214 is positioned between ends 210A and 210B. End 2209 of first meander vibration beam 209 having end 1209 connected to mirror 208 is connected to end 210B of movable frame 210. End 1211 of second meander vibration beam 211 is connected to end 210A of movable frame 210.

Mirror 208 has ends 208A and 208B opposite to each other along second rotation axis 214. That is, ends 208A and 208B are positioned opposite to each other across first rotation axis 213 in between, and first rotation axis 213 is positioned between ends 208A and 208B. End 1209 of first meander vibration beam 209 is connected to end 208A of mirror 208. First meander vibration beam 209 of optical reflection device 1003 can rotate and swing mirror 208 by larger amplitude due to leverage effects than an optical reflection device in which end 1209 of first meander vibration beam 209 is connected to the center of a side of mirror 208 Meanwhile, as compared to an optical reflection device in which end 1211 of second meander vibration beam 211 is connected to the center of the side of movable frame 210, second meander vibration beam 211 of optical reflection device 1003 can rotate and swing movable frame 210 (i.e. mirror 208) with large amplitude due to leverage.

End 2209 connected to movable frame 210 of first meander vibration beam 209 is positioned on first rotation axis 213. End 2211 connected to supporter 212 of second meander vibration beam 211 is positioned on second rotation axis 214. This arrangement stabilizes the positions of rotation axes 213 and 214, thereby preventing unnecessary vibration.

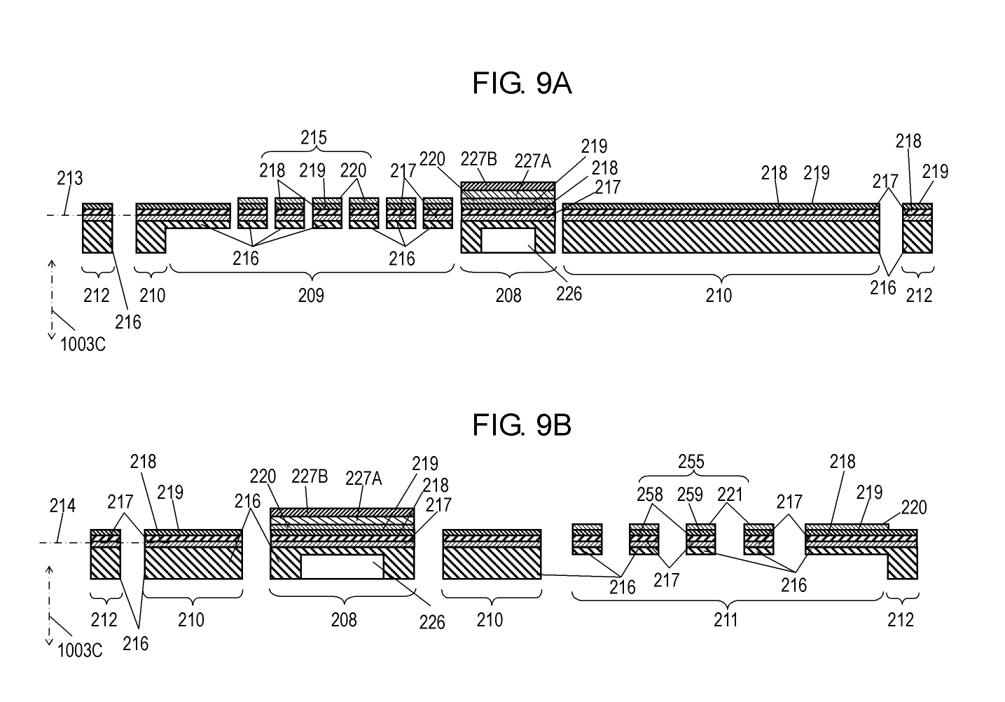

FIGS. 9A and 9B are sectional views of optical reflection device 1003 shown in FIG. 8 at first rotation axis 213 and second rotation axis 214, respectively. Piezoelectric actuators 215 and 255 are provided on surfaces of meander vibration beams 209 and 211 directed in direction 1003C perpendicular to rotation axes 213 and 214, respectively. Mirror 208, meander vibration beams 209 and 211, movable frame 210, and supporter 212 have common silicon substrate 216. Silicon oxide film 217 is provided on silicon substrate 216. Piezoelectric actuator 215 provided on first meander vibration beam 209 includes lower electrode layer 218 provided on silicon oxide film 217, piezoelectric layer 219 provided on lower electrode layer 218, and upper electrode layer 220 provided on piezoelectric layer 219. Piezoelectric actuator 255 provided on second meander vibration beam 211 includes lower electrode layer 258 provided on silicon oxide film 217, piezoelectric layer 259 provided on lower electrode layer 258, and upper electrode layer 220 provided on piezoelectric layer 259. Upper electrode layers 220 and 221 are patterned to have predetermined patterns by etching. Lower electrode layers 218 and 258 may be grounded.

In optical reflection device 1003, portions of a lower surface of silicon substrate 216 corresponding to meander vibration beams 209 and 211 and mirror 208 are etched to make meander vibration beams 209 and 211 and mirror 208 thinner than movable frame 210 and supporter 212. Meander vibration beams 209 and 211 are thin to elastically deform, hence increasing rotation angles θH and θV. A large thickness of movable frame 210 allows movable frame 210 to function as a weight connected to second meander vibration beam 211, increasing rotation angle θV about second rotation axis 214. A large thickness of supporter 212 allows optical reflection device 1003 to be handled easily and increases the mechanical strength of optical reflection device 1003.

Lower electrode layers 218 and 258 may be made of platinum. Upper electrode layers 220 and 221 may be made of gold. Piezoelectric layer 219 and 259 may be made of lead zirconate titanate, Pb(Zrₓ, Ti₁₋ₓ)O₃, (x=0.525). These layers can be formed by a film-forming method, such as deposition, sol-gel method, chemical vapor deposition (CVD), or sputtering.

An operation of optical reflection device 1003 will be described below.

An alternating-current (AC) voltage having a resonance frequency intrinsic to first meander vibration beam 209 is applied between upper electrode layer 220 and lower electrode layer 218 of piezoelectric actuator 215 provided on first meander vibration beam 209 to drive piezoelectric actuator 215. Similarly, an AC voltage having a resonance frequency intrinsic to second meander vibration beam 211 is applied between upper electrode layer 221 and lower electrode layer 258 of piezoelectric actuator 255 provided on second meander vibration beam 211 to drive piezoelectric actuator 255.

The polarity of the AC voltage supplied to upper electrode layer 220 changes, and accordingly, first meander vibration beam 209 vibrates about first rotation axis 213. Mirror 208 rotates and swings about first rotation axis 213 while crossing point 208E inside mirror 208 is not displaced due to this vibration.

Similarly, with the polarity of the AC voltage supplied to upper electrode layer 221 changes, and accordingly, second meander vibration beam 211 vibrates about second rotation axis 214. This vibration causes movable frame 109 to vibrate about second rotation axis 214, and rotates and swings mirror 208 about second rotation axis 214 while crossing point 208E inside mirror 208 is not displaced.

Meander vibration beams 209 and 211 are driven at their respective resonance frequencies to increase rotation angles θH and θV by which mirror 208 and movable frame 210 rotate.

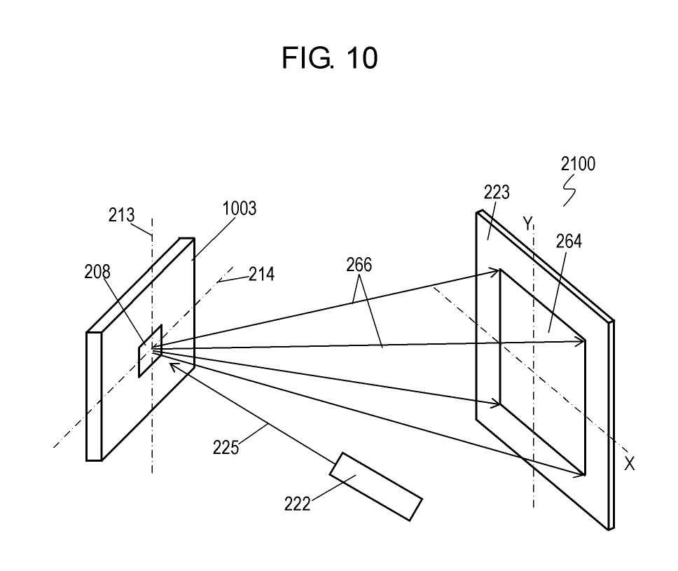

FIG. 10 is a schematic diagram of image projector 2100 including optical reflection device 1003. Light 225 is emitted onto mirror 208 from light source 222, such as a laser light source. Mirror 208 reflects light 225 to reflect light 225 to screen 223 while rotating and swinging about rotation axes 213 and 214. While mirror 208 rotates about first rotation axis 213, reflected light 266 scans screen 223 in a direction of an X-axis perpendicular to first rotation axis 213. Similarly, while mirror 208 rotates about second rotation axis 214, reflected light 266 scans screen 223 in a direction of a Y-axis perpendicular to second rotation axis 214. Thus, mirror 208 of optical reflection device 1003 allows reflected light 266 to scan screen 223 in the directions of the X-axis and the Y-axis, thereby projecting image 264 on screen 223.

Movable frame 210 is coupled to supporter 212 only via single second meander vibration beam 211, thereby allowing optical reflection device 1003 to have a small size. In conventional optical reflection device 501 shown in FIG. 16, two meander vibration beams 204 located opposite to each other across movable frame 203 are connected to movable frame 203. Meander vibration beams 204 occupy a certain area. Hence, optical reflection device 1003 according to Embodiment 3 has a smaller size than conventional optical reflection device 501.

In conventional optical reflection device 501 shown in FIG. 16, meander vibration beams 204 apply restraint forces on movable frame 210 from both sides, thereby increasing a vibration frequency of meander vibration beams 204. In optical reflection device 1003 according to Embodiment 3, movable frame 210 is coupled to supporter 212 only via single second meander vibration beam 211, and have a restraint force restraining vibration of movable frame 210 reduced, thereby decreasing frequency fV at which second meander vibration beam 211 vibrates. Thus, ratio fH/fV of frequency fH of vibration of mirror 208 about first rotation axis 213 to frequency fV about second rotation axis 214 can increase, and accordingly increases the resolution of image 264 projected, allowing image projector 2100 to project high-resolution image 264 on screen 223.

Movable frame 210 is preferably rotates and vibrates in parallel with second rotation axis 214 about second rotation axis 214. However, in the case that movable frame 210 is supported by being coupled to supporter 212 only via single second meander vibration beam 211, the gravity center of movable frame 210 may be displaced more largely than movable frame 203 supported by two meander vibration beams 204 shown in FIG. 16, and thus, movable frame 210 may incline with respect to second rotation axis 214.

In optical reflection device 1003 according to Embodiment 3, first meander vibration beam 209 is connected to end 210B of movable frame 210, and second meander vibration beam 211 is connected to movable frame 210 at end 210A opposite to end 210B across second rotation axis 214. This structure prevents movable frame 210 from inclining with respect to second rotation axis 214 while movable frame 210 vibrates, thereby preventing unnecessary vibration.

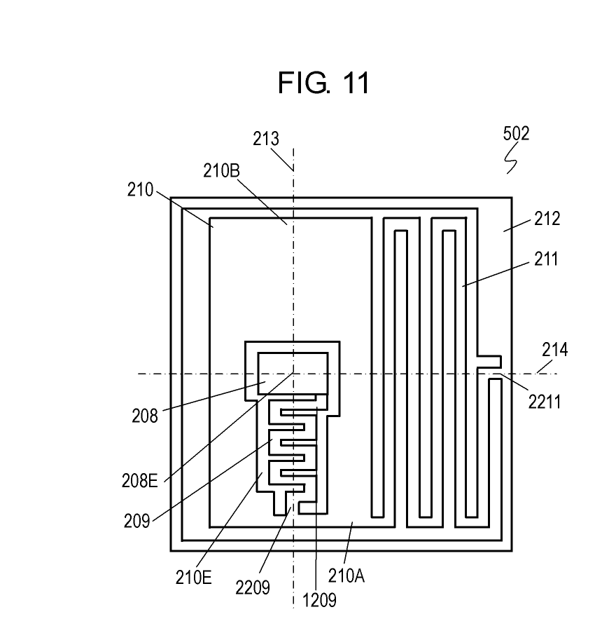

In order to evaluate examine unnecessary vibration of movable frame 210, samples of optical reflection device 1003 according to Embodiment 1 shown in FIG. 8 as example 1 were produced. FIG. 11 is a top view of comparative example 1 of optical reflection device 502. In FIG. 11, components identical to those of optical reflection device 1003 shown in FIG. 8 are denoted by the same reference numerals, and their description will be omitted. In example 2 of optical reflection device 502 shown in FIG. 11, end 2209 of first meander vibration beam 209 is connected not to end 210B of movable frame 210, but to end 210A to which second meander vibration beam 211 is connected. In order to evaluate examine unnecessary vibration of movable frame 210, samples of example 2 of optical reflection device 502 shown in FIG. 11 were produced as well.

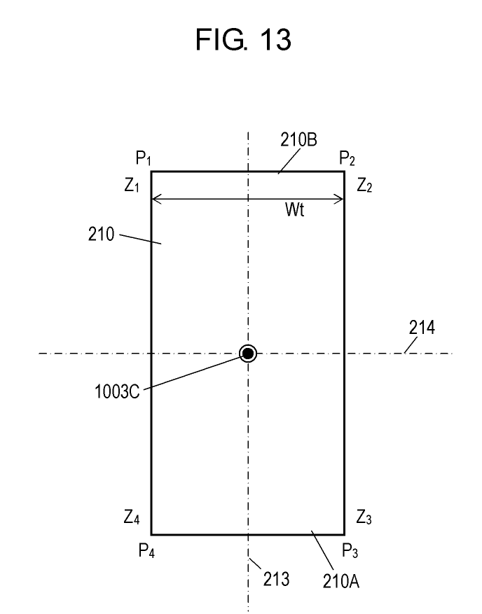

FIG. 13 is a schematic diagram of movable frame 210. Movable frame 210 is a rectangular shape having four vertices P₁, P₂, P₃, and P₄, sides P₁P₂ and P₃P₄ parallel to second rotation axis 214, and sides P₂P₃ and P₄P₁ parallel to first rotation axis 213. Angle θE of the rotation axis of movable frame 210 with respect to second rotation axis 214 was determined. As shown in FIG. 13, four vertices P₁, P₂, P₃, and P₄ of movable frame 210 vibrated at amplitudes Z₁, Z₂, Z₃, and Z₄, respectively, in direction 1003C perpendicular to rotation axes 213 and 214. Angle θE is expressed by formula 1 with length Wt of sides P₁P₂ and P₃P₄.

$$θ E = \frac{{sin}^{- 1} ( \frac{\vert {Z}_{1} - {Z}_{2} \vert}{Wt} ) + {sin}^{- 1} ( \frac{\vert {Z}_{3} - {Z}_{4} \vert}{Wt} )}{2} \qquad ( Formula 1 )$$

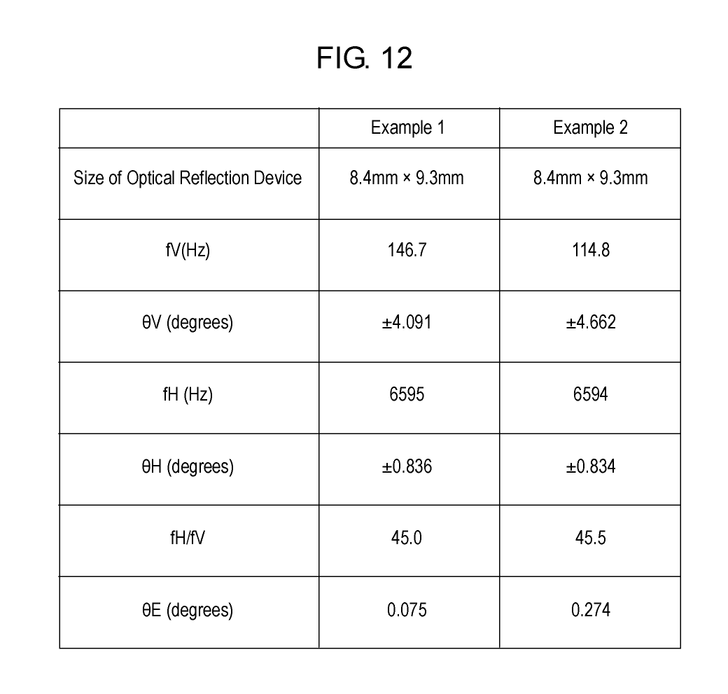

FIG. 12 shows angle θE of movable frame 210 inclining with respect to second rotation axis 214 of optical reflection device 1003 according to Embodiment 1 and example 2 of optical reflection device 502. As shown in FIG. 12, example 2 of optical reflection device 502 exhibited angle θE of 0.274 degrees of movable frame 210 inclining with respect to second rotation axis 214, while optical reflection device 1003 according to Embodiment 1 exhibited angle θE of 0.075 degrees. Thus, optical reflection device 1003 according to Embodiment 1 provides smaller angle θE of movable frame 210 inclining with respect to second rotation axis 214 than example 2 of optical reflection device 502, accordingly preventing unnecessary vibration.

Movable frame 210 receives a force due to the rotation and vibration of second meander vibration beam 211 at a portion (end 210A) where movable frame 210 is connected to second meander vibration beam 211, and thus, is displaced with end 210A as a point for receiving the force. Since second meander vibration beam 211 is connected to end 210A of movable frame 210, end 210A of movable frame 210 is displaced largely, and end 210B opposite to end 210A is less displacement. Hence, the rotation axis of movable frame 210 moves to a position deviating from second rotation axis 214 toward end 210B.

Movable frame 210 connected to second meander vibration beam 211 is influenced by second meander vibration beam 211 rotating about second rotation axis 214. The rotation axis of movable frame 210 deviating from the rotation axis of second meander vibration beam 211 causes the rotation axis of movable frame 210 to incline with respect to second rotation axis 214.

In optical reflection devices 501 and 1003 shown in FIGS. 8 and 11, first meander vibration beam 209 is formed by providing slit 210E in movable frame 210 to arrange first meander vibration beam 209 inside movable frame 203. Hence, the weight of a portion of movable frame 210 wherein first meander vibration beam 209 is formed therein is smaller than the weight of a portion of movable frame 210 where first meander vibration beam 209 is not formed therein.

In example 2 of optical reflection device 502 shown in FIG. 11, the weight of a portion of movable frame 210 between second rotation axis 214 and end 210A is smaller than that of a portion of movable frame 210 between second rotation axis 214 and end 210B. Hence, in example 2 of optical reflection device 502, the portion of movable frame 210 between second rotation axis 214 and end 210A may be displaced more than that of the portion of movable frame 210 between second rotation axis 214 and end 210B. This increases a deviation of the rotation axis of movable frame 210 from second rotation axis 214, accordingly increasing angle θE of movable frame 210 inclining toward second rotation axis 214.

In optical reflection device 1003 according to Embodiment 1 shown in FIG. 8, the weight of the portion of movable frame 210 between second rotation axis 214 and end 210B is smaller than that of the portion of movable frame 210 between second rotation axis 214 and end 210A. Hence, the portion of movable frame 210 between second rotation axis 214 and end 210B may be displaced more than that of the portion of movable frame 210 between second rotation axis 214 and end 210A. Hence, optical reflection device 1003 has the rotation axis of movable frame 210 closer to second rotation axis 214 than example 2 of optical reflection device 502 is, thus decreasing angle θE.

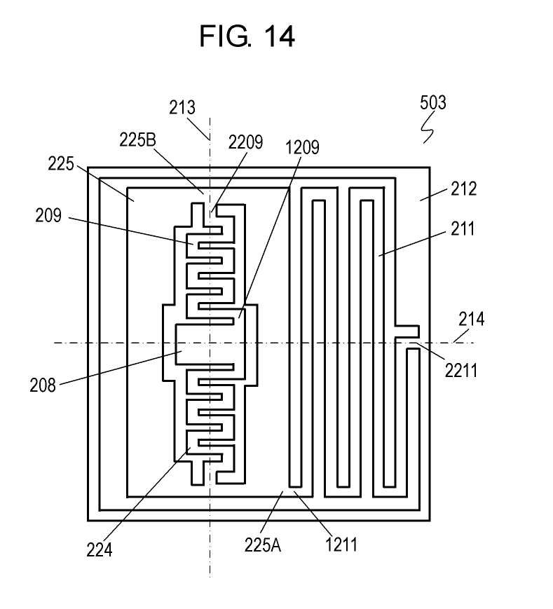

FIG. 14 is a top view of comparative example 1 of optical reflection device 503. In FIG. 14, components identical to those of optical reflection device 1003 shown in FIG. 8 are denoted by the same reference numerals, and their description will be omitted. Optical reflection device 503 shown in FIG. 14 includes movable frame 225 instead of movable frame 210 of optical reflection device 1003 shown in FIG. 8, and further includes meander vibration beam 224 connected to mirror 208. Meander vibration beam 224 extends meanderingly along first rotation axis 213 and is connected to end 225A of movable frame 210. More specifically, in optical reflection device 503, mirror 208 is support by being connected to ends 210A and 210B of movable frame opposite to each other about movable frame 210 via first meander vibration beam 209 and meander vibration beam 224. That is, movable frame 225 has a shape symmetrical about second rotation axis 214, and the weight of the portion of movable frame 225 between second rotation axis 214 and end 210A is the same as the portion of movable frame 225 between second rotation axis 214 and end 210B. A sample of comparative example 1 of optical reflection device 502 was produced. In optical reflection device 503, the angle θE by which movable frame 225 inclines with respect to second rotation axis 214 was 0.330 degrees. Thus, optical reflection device 1003 shown in FIG. 8 has smaller angle θE by which the rotation axis of movable frame 210 inclines with respect to second rotation axis 214 than optical reflection device 503 shown in FIG. 14, thus reducing unnecessary vibration.

In optical reflection device 1003 according to Embodiment 3 shown in FIGS. 9A and 9B, recess 226 is provided in the lower surface of mirror 208, and a portion of silicon substrate 216 inside mirror 208 is thinner than a portion of silicon substrate 216 at the outer periphery of mirror 208. Optical reflection device 1003 may further include weight layer 227A provided on the upper surface of mirror 208 and reflection layer 227B provided on weight layer 227A. Reflection layer 227B is made of material, such as silicon, having high optical reflectance. Weight layer 227A is made of material, such as copper, having a high specific gravity, thereby functioning as a weight even if weight layer 227A is thin. Thin weight layer 227A can be formed in a short time. If weight layer 227A is made of material, such as silicon, having high optical reflectance, optical reflection device 1003 does not necessarily include reflection layer 227B.

Recess 226 is provided in the lower surface of mirror 208, and weight layer 227A is provided on the upper surface of mirror 208. This structure locates the gravity center of mirror 208 on first rotation axis 213 of first meander vibration beam 209. This arrangement prevents the axis about which mirror 208 rotates and vibrates from inclining due to deviation of the center of mirror 208 from first rotation axis 213, thereby reducing unnecessary vibration of mirror 208 while rotating and vibrating. The depth of recess 226 may be identical to the depth to which silicon substrate 216 is etched in order to thin meander vibration beams 209 and 211. This arrangement allows recess 226 to be formed by the same process as meander vibration beams 209 and 211, thereby allowing optical reflection devices 1003 to be manufactured efficiently.

Optical reflection device 1003 shown in FIG. 8 does not include meander vibration beam 224 of optical reflection device 502 shown in FIG. 14. Hence, movable frame 210 can be larger by expanding movable frame 210 to a portion of movable frame 210 corresponding to meander vibration beam 224. This structure increases frequency fV of the vibration and rotation angle θV of the rotation of the mirror 208 (movable frame 210) about second rotation axis 214 due to deformation of second meander vibration beam 211.

Thus, frequency fV of the vibration during the rotation about second rotation axis 214 is decreased, and ratio fH/fV of frequency fH to frequency fV is increased. This increases the number of scanning lines of image 264 in the X-axis direction, accordingly allowing optical reflection device 1003 to project high resolution image 264 on screen 223.

### Exemplary Embodiment 4

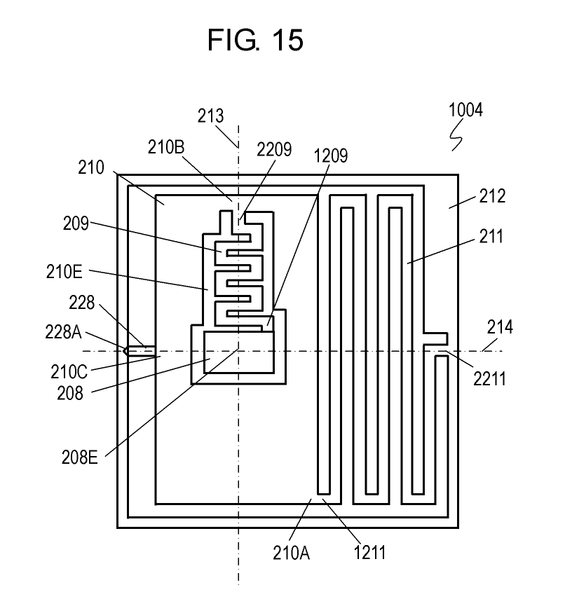

FIG. 15 is a top view of optical reflection device 1004 according to Embodiment 4. In FIG. 15, components identical to those of optical reflection device 1003 according to Embodiment 3 shown in FIG. 8 are denoted by the same reference numerals, and their description will be omitted. Optical reflection device 1004 shown in FIG. 15 includes optical reflection device 1003 according to Embodiment 3 shown in FIG. 8 and further includes gimbal shaft 228 connecting movable frame 210 to supporter 212. Gimbal shaft 228 is connected to end 210C opposite to end 210A, across first rotation axis 213, to which second meander vibration beam 211 of movable frame 210 is connected.

Gimbal shaft 228 is rotatably supported by supporter 212, fir example, by groove 228A formed in supporter 212). Gimbal shaft 228 is connected to movable frame 210 on second rotation axis 214. Gimbal shaft 228 is not fixed to supporter 212, but is supported on supporter 212 rotatably about second rotation axis 214, and supports movable frame 210 so that movable frame 210 rotates about second rotation axis 214. This structure prevents the gravity center of movable frame 210 from deviating while vibrating, thereby preventing unnecessary vibration of movable frame 210 and mirror 208. Second meander vibration beam 211 rotates and vibrates movable frame 210, but restrains the rotation of movable frame 210. Gimbal shaft 228 does not substantively restrain the rotation of movable frame 210 about second rotation axis 214 except for inevasible physical actions, such as friction. Gimbal shaft 228 does not decrease rotation angle θV of movable frame 210, i.e., mirror 208, about second rotation axis 214.

Optical reflection devices 1003 and 1004 according to Embodiments 3 and 4 can have small sizes, and are applicable to small image projectors included in, e.g. portable phones.

What is claimed is:

1. An optical reflection device comprising:
a mirror adapted to reflect light thereon;
a first meander vibration beam meanderingly extending along a first rotation axis, the first meander vibration beam having a first end and a second end opposite to the first end, the first end being connected to the mirror, the first meander vibration beam supporting the mirror rotatably about the first rotation axis;
a movable frame connected to the second end of the first meander vibration beam;
a second meander vibration beam extending meanderingly along a second rotation axis perpendicular to the first rotation axis, the second meander vibration beam having a third end and a fourth end opposite to the third end, the third end being connected to the movable frame, the second meander vibration beam supporting the movable frame rotatably about the second rotation axis; and
a supporter connected to the fourth end of the second meander vibration beam,
wherein the mirror is coupled to the movable frame only via the first meander vibration beam.

2. The optical reflection device of claim 1, wherein the movable frame surrounds the first meander vibration beam and the mirror.

3. The optical reflection device of claim 1, further comprising:
a first piezoelectric actuator vibrating the first meander vibration beam; and
a second piezoelectric actuator vibrating the second meander vibration beam.

4. The optical reflection device of claim 1, further comprising a further meander vibration beam extending meanderingly along the first rotation axis, the further meander vibration beam having an end connected to the mirror.

5. The optical reflection device of claim 1, further comprising a weight layer provided on the mirror, the weight layer having a first surface adapted to reflect the light.

6. The optical reflection device of claim 5, wherein
the mirror further has a second surface opposite to the first surface,
the second surface of the mirror has a projection thereon and has a recess formed therein, and
a thickness of the projection of the mirror is larger than a thickness of the first meander vibration beam.

7. The optical reflection device of claim 1, wherein the supporter has a frame shape surrounding the second meander vibration beam and the movable frame.

8. The optical reflection device of claim 1, wherein a crossing point at which the first rotation axis and the second rotation axis cross is located inside the mirror.

9. The optical reflection device of claim 8, wherein the crossing point is located at a gravity center of the mirror.

10. The optical reflection device of claim 1, wherein the movable frame is coupled to the supporter only via the second meander vibration beam.

11. The optical reflection device of claim 10, wherein the second end of the first meander vibration beam and the fourth end of the second meander vibration beam are located opposite to each other about the second rotation axis.

12. The optical reflection device of claim 1, further comprising a gimbal shaft connected to an end of the movable frame located opposite to the third end of the second meander vibration beam about the first rotation axis, the gimbal shaft being connected to the supporter, the gimbal shaft rotatably supporting the movable frame.

13. The optical reflection device of claim 12, wherein the gimbal shaft is located on the second rotation axis.

14. An image projector comprising:
the optical reflection device according to claim 1; and
a light source emitting the light to be reflected by the optical reflection device.
